(19) United States
(12) Patent Application Publication
(10) Pub. No.: US 2015/0232040 A1
(43) Pub. Date: Aug. 20, 2015

(54) Golf Cart Towel Hook

(71) Applicant: Kenneth Wirtjes, Covina, CA (US)

(72) Inventor: Kenneth Wirtjes, Covina, CA (US)

(21) Appl. No.: 14/621,280

(22) Filed: Feb. 12, 2015

Related U.S. Application Data
(60) Provisional application No. 61/940,943, filed on Feb. 18, 2014.

(51) Int. Cl. B60R 9/08; A63B 71/00; A63B 57/00

(52) U.S. Cl. CPC B60R 9/08; A63B 57/00; A63B 71/0036

(57) ABSTRACT

A golf towel hook is attached to a golf cart to allow simple and secure carrying of the golf towel. The hook includes a slot for a strap, and the strap may be used to temporarily attach the hook to vertical roof supports of a rental golf cart in front of the golfers or easy access. The hook may alternatively be permanently attached to the vertical roof supports using screws. Because the towels generally include eyelets, the hooks preferably include a catch curving inward at the end of the hook to better retain a spring clip attached through the eyelet.

### CROSS-REFERENCE TO RELATED APPLICATIONS

The present application claims the priority of U.S. Provisional Patent Application Ser. No. 61/940,943 filed Feb. 18, 2014, which application is incorporated in its entirety herein by reference.

### BACKGROUND OF THE INVENTION

The present invention relates to the game of golf and in particular to a golf towel holder attachable to a golf cart.

Golfers generally carry a small wetted golf towel to clean their golf clubs and balls between shots. The clubs and balls often collect moisture, grass clipping, and mud during use which affects play. The golfers may carry the golf towels in various ways including in their golf bag or in their pocket, but as the golf towels become soiled, these options are less attractive. Further, when the golf towels are not carried securely, they are often dropped and lost.

Further, the golf towel may include a spring clip passing through an eyelet in the towel, an eyelet only, or be a plain towel with no eyelet. Thus a need is present for a golf cart attachment suitable to carry all of the three possible towels.

### BRIEF SUMMARY OF THE INVENTION

The present invention addresses the above and other needs by providing a golf towel hook which is attached to a golf cart to allow simple and secure carrying of the golf towel. The hook includes a slot for a strap, and the strap may be used to temporarily attach the hook to vertical roof supports of a rental golf cart in front of the golfers for easy access. The hook may alternatively be permanently attached to the vertical roof supports using screws. Because the towels generally include eyelets, the hooks preferably include a catch curving inward at the end of the hook to better retain a spring clip attached through the eyelet.

In accordance with one aspect of the invention, there is provided a towel hook with a slot for temporary attachment with a strap, and screw holes for permanent attachment, to a golf cart.

In accordance with another aspect of the invention, there is provided a towel hook with a catch at the end of a hook portion to better retain a spring clip in the towel hook when the golf cart is in motion.

In accordance with yet another aspect of the invention, there is provided a towel hook with a small hook portion allowing a towel eyelet to slide over the hook when a spring clip is not attached to the towel.

In accordance with still another aspect of the invention, there is provided a towel hook with a ½″ space between the inside edge of the hook and the inside face of the hook body providing adequate space to hang a towel over the hook, or to place a cigar (ring size 55 or greater) so the golfer does not have to lay the cigar down on the ground near the green (which is frequently forgotten and left where it lay).

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a golf cart with a towel hook according to the present invention attached.

FIG. 2A shows a towel with an eyelet and spring clip attached to the towel hook according to the present invention attached.

FIG. 2B shows a towel with an eyelet attached to the towel hook according to the present invention attached.

FIG. 2C shows a towel wrapped over the towel hook according to the present invention attached.

FIG. 2D shows a cigar carried by the towel hook according to the present invention attached.

FIG. 3 shows a side view of the towel hook according to the present invention attached showing a slot for an attachment strap.

FIG. 4 shows a perspective view of the towel hook according to the present invention attached.

FIG. 4A shows a front view of the towel hook according to the present invention attached.

FIG. 4B shows a side view of the towel hook according to the present invention attached.

FIG. 4C shows a rear view of the towel hook according to the present invention attached.

FIG. 4D shows a top view of the towel hook according to the present invention attached.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

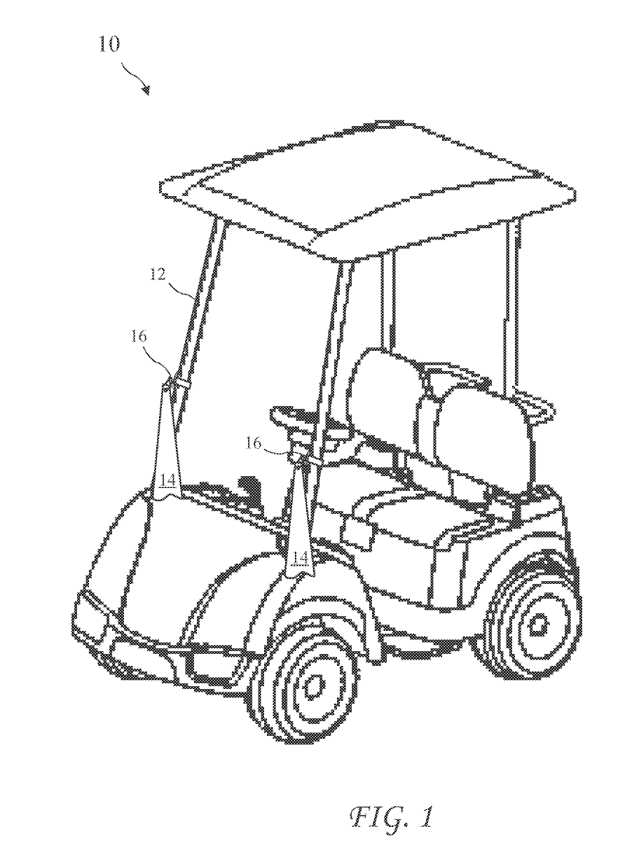

A golf cart 10 with a towel hook 16 according to the present invention attached is shown in FIG. 1. The golf cart 10 includes a vertical roof support 12 and the towel hook 16 is attached to the vertical roof support 12. A golf towel 14 is held by the towel hook 16.

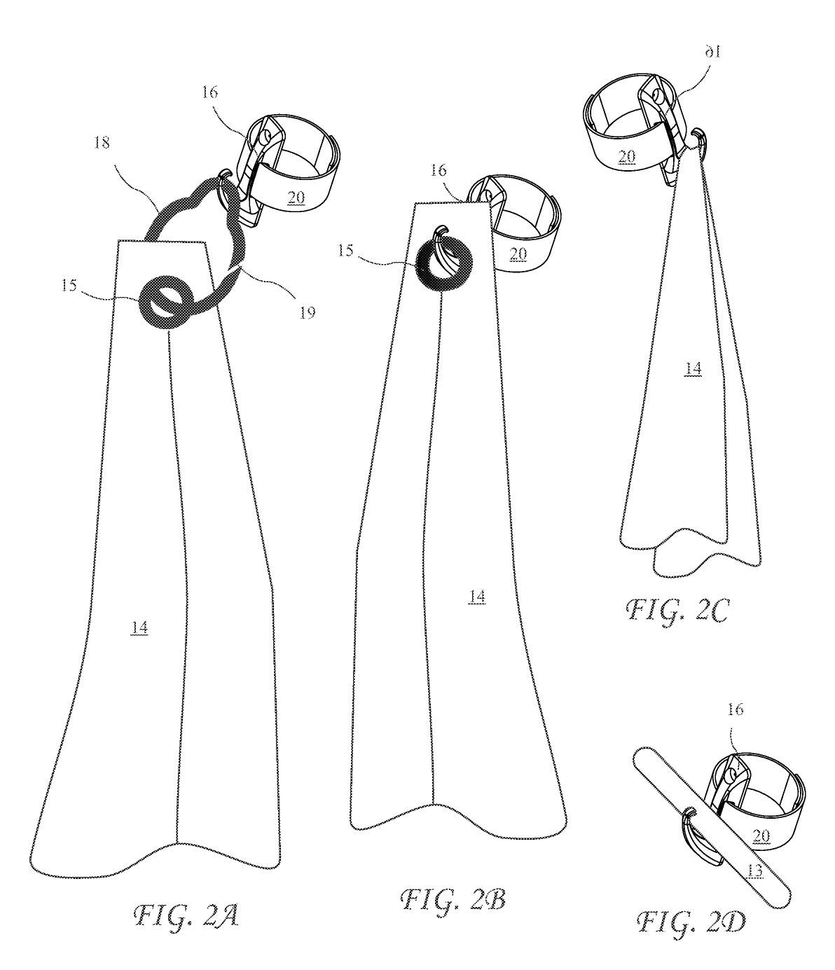

A more detailed view of the golf towel 14 attached to the towel hook 16 by a spring clip 18 is shown in FIG. 2A, the golf towel 14 attached to the towel hook 16 by an eyelet 15 is shown in FIG. 2B, the golf towel 14 hung over the towel hook 16 is shown in FIG. 2C, and a cigar 13 carried by the towel hook 16 is shown in FIG. 2D. The dimensions and shape of the towel hook 16 are carefully selected to allow the golf towel 14 to be carried by the towel hook 16 in all three configurations. Additionally, golfer's often enjoy a cigar, and the towel hook 16 dimensions were selected to allow the golfer to rest his cigar in the towel hook 16.

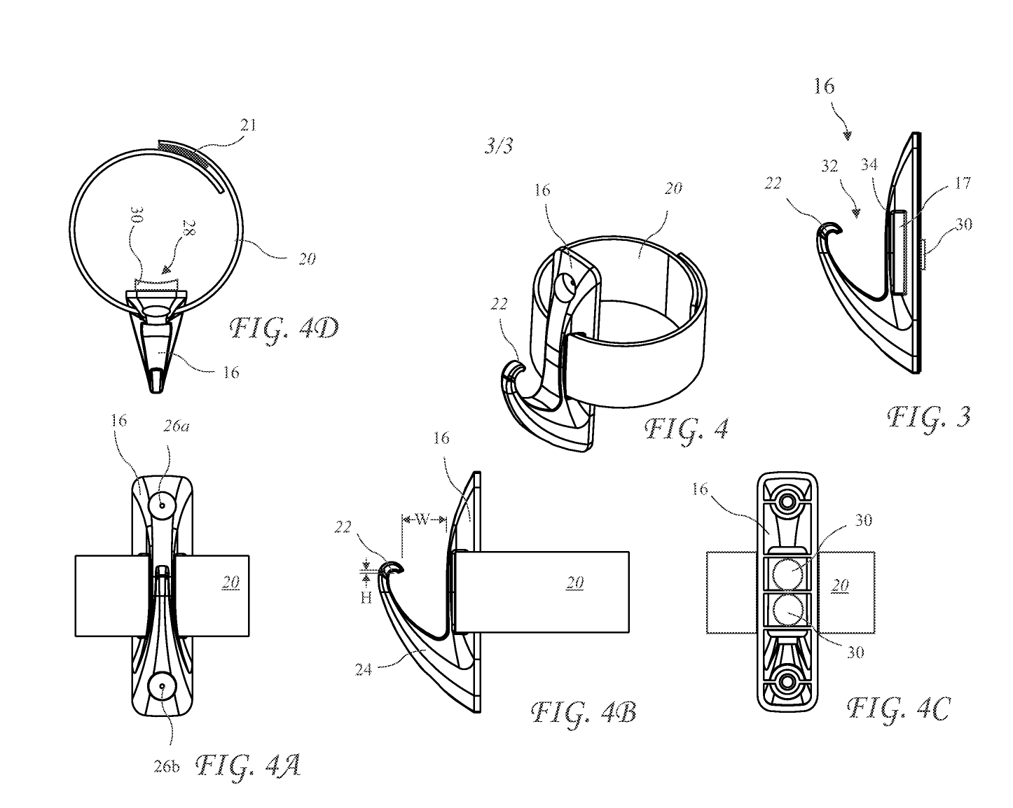

A side view of the towel hook 16 only is shown in FIG. 3, a perspective view of the towel hook 16 and strap 20 is shown in FIG. 4, a front view of the towel hook 16 and strap 20 is shown in FIG. 4A, a side view of the towel hook 16 and strap 20 is shown in FIG. 4B, a rear view of the towel hook 16 and strap 20 is shown in FIG. 4C, and a top view of the towel hook 16 and strap 20 is shown in FIG. 4D. The strap 20 passed through the slot 17 and is attached around the vertical roof support 12. The strap may include hook and loop material 21 to close the strap, or a buckle, snap, or any closing features to connect ends of the strap 20. An example of a suitable strap is four inches long to reach around the vertical roof support 12.

The towel hook 16 includes a catch 22 curving inward and at least slightly downward at the end of a hook portion 24 to better retain the spring clip 18 attached through the eyelet 15. While the strap 20 is preferred to temporary attachment of the towel hook, for example, to rented golf carts, the towel hook 16 may also include screw holes 26a and 26b for more permanent attaching to the golf cart 10. The towel hook 16 includes a flat mounting surface 28 for attaching a rectangular vertical roof support 12, or curved in one dimension, mounting surface 28 for attaching a round vertical roof support 12. For example, the mounting surface 28 may be a cylindrical portion having a straight vertical cross-section and a curved horizontal cross-section to conform to a tubular vertical roof support 12. At least one bumper 30 of rubber or similar material may be attached to the mounting surface 28 to resist the towel hook 16 slipping on the vertical roof support 12. The bumper 30 may have a flat back and curved front to provide the curved mounting surface 28, and may be two round bumpers attached to the mounting surface 28.

The towel hook 16 defines a mouth 32 between the towel hook body 34 and the catch 22. The mouth 32 has a width W of preferably between 0.4 and 0.7 inches, and more preferably between 0.5 and 0.6 inches, and most preferably 0.5 inches. The catch 22 curves towards the body 34 and down a height H of preferably between 0.01 and 0.1 inches, and more preferably between 0.01 and 0.03 inches, and most preferably 0.02 inches. The towel hook 16 so defined is suitable for carrying a towel 14 by a spring clip 18, by an eyelet 15, by the towel 14 wrapped over the towel hook 16, or carrying a golfer's cigar.

While the invention herein disclosed has been described by means of specific embodiments and applications thereof, numerous modifications and variations could be made thereto by those skilled in the art without departing from the scope of the invention set forth in the claims.

I claim:

1. A golf towel hook comprising:
a mounting surface;
a strap for attachment to a golf cart;
a vertical slot for receiving the strap; and
an upward and outward hooked portion.

2. The golf towel hook of claim 1, wherein the hooked portion further includes a catch portion curving inward to better retain a golf towel.

3. The golf towel hook of claim 1, wherein the hooked portion further includes a catch portion curving inward and downward to better retain a golf towel.

4. The golf towel hook of claim 3, wherein an open mouth is defined between the catch portion and the towel hook body for receiving a spring clip, an eyelet, and a towel wrapped over the towel hook.

5. The golf towel hook of claim 4, wherein the open mouth has a width between 0.4 and 0.7 inches.

6. The golf towel hook of claim 5, wherein the catch portion curves towards the towel hook body and down.

7. The golf towel hook of claim 5, wherein the catch portion curves down a height H between 0.01 and 0.1 inches.

8. The golf towel hook of claim 1, further including at least one passage for a screw to permanently attach the golf towel hook to a golf cart.

9. A golf towel hook comprising:
a flat mounting surface;
a strap for attachment to a golf cart;
a vertical slot for receiving the strap;
an upward and outward hooked portion including a catch portion curving inward and downward to better retain a golf towel; and
an open mouth between the catch portion and the towel hook body for receiving a spring clip, an eyelet, and a towel wrapped over the towel hook, the open mouth has a width between 0.4 and 0.7 inches and the catch portion curving down a height H between 0.01 and 0.1 inches.

10. A method for carrying a golf towel on a golf cart, the method comprising:
obtaining a golf towel hook comprising:
a flat mounting surface;
a strap for attachment to a golf cart;
a vertical slot for receiving the strap; and
an upward and outward hooked portion;
passing the strap through the slot in the golf towel hook;
attaching the strap around a vertical roof support of a rental golf cart in front of the golfers;
obtaining a golf towel having an eyelet fixed at open end;
attaching a spring clip through the eyelet; and
hooking the spring clip over the golf towel hook.
